(19) United States
(12) Patent Application Publication
(10) Pub. No.: US 2025/0075962 A1
(43) Pub. Date: Mar. 6, 2025

(54) REFRIGERATOR DOOR HINGE

(71) Applicant: Haier US Appliance Solutions, Inc., Wilmington, DE (US)

(72) Inventors: Sachin Nagane, Louisville, KY (US); Emily Ashburn, Louisville, KY (US)

(21) Appl. No.: 18/456,912

(22) Filed: Aug. 28, 2023

(51) Int. Cl. F25D 23/02

(52) U.S. Cl. CPC F25D 23/028; F25D 2323/024

(57) ABSTRACT

A refrigerator appliance includes a cabinet defining a food storage chamber. A door is coupled to the cabinet by a hinge. The hinge includes a hinge bracket fixedly mounted to the cabinet and a cam formed on the hinge bracket. The hinge bracket comprises a metal material and the cam comprises a plastic material.

### FIELD OF THE INVENTION

The subject matter of the present disclosure relates generally to appliances having a cabinet and a door rotatably coupled to the cabinet by a hinge. For example, such appliances may include refrigerator appliances.

### BACKGROUND OF THE INVENTION

Refrigerator appliances generally include a cabinet that defines one or more chilled chambers for receipt of food items for storage. One or more insulated, sealing doors are provided for selectively enclosing the chilled food storage chamber(s). Generally, the door(s) are coupled to the cabinet by one or more hinges such that the door is movable between a closed position and an open position for accessing food items stored therein by pulling on the door(s), such as by pulling on a handle on the door.

Some refrigerator appliances include features for assisting in closing the door or ensuring that the door is fully closed, e.g., to ensure sealing engagement with the cabinet. Such features thus generally include multiple moving parts which interface with each other every time the door is opened and/or closed. Over time, e.g., after repeated opening and closing cycles, such parts may wear down and result in reduced effectiveness. For example, where interfacing parts are made of differing materials, such as materials of differing hardnesses, e.g., metal and plastic, one of the materials may experience excessive wear.

Accordingly, a refrigerator appliance having an improved hinge is desired in the art. For example, refrigerator appliances and door hinges therefor which include features for extending the usable life of the hinge are desired in the art.

### BRIEF DESCRIPTION OF THE INVENTION

Aspects and advantages of the invention will be set forth in part in the following description, or may be apparent from the description, or may be learned through practice of the invention.

In an exemplary embodiment, a refrigerator appliance is provided. The refrigerator appliance defines a vertical direction, a lateral direction, and a transverse direction. The vertical, lateral, and transverse directions are mutually perpendicular. The refrigerator appliance includes a cabinet defining a food storage chamber. The food storage chamber extends between a front portion and a back portion along the transverse direction. The front portion of the food storage chamber defines an opening for receipt of food items. A door is positioned at the front portion of the food storage chamber. The door is coupled to the cabinet by a hinge. As a result of such coupling, the door is movable between a closed position and an open position to selectively sealingly enclose the food storage chamber in the closed position and provide access to the food storage chamber in the open position. The hinge includes a hinge bracket fixedly mounted to the cabinet and a cam formed on the hinge bracket. The hinge bracket includes a metal material and the cam includes a plastic material.

In another exemplary embodiment, a hinge for a door of a refrigerator appliance is provided. The hinge includes a hinge bracket configured to fixedly mount to a cabinet of the refrigerator appliance and a cam formed on the hinge bracket. The hinge bracket includes a metal material and the cam includes a plastic material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a refrigerator appliance according to an exemplary embodiment of the present subject matter with a door of the refrigerator appliance shown in the closed position.

FIG. 2 provides a front elevation view of the exemplary refrigerator appliance of FIG. 1 with the door shown in an open position.

FIG. 3 provides a cross-section view of the door taken along line 3-3 in FIG. 2.

FIG. 4 illustrates a hinge bracket and cam of an exemplary hinge according to one or more embodiments of the present subject matter which may be incorporated into appliances such as the refrigerator appliance of FIG. 1.

FIG. 5 illustrates a hook of an exemplary hinge according to one or more embodiments of the present subject matter which may be incorporated into appliances such as the refrigerator appliance of FIG. 1.

FIG. 6 illustrates a portion of a hinge with the cam and the hook while the door is in an intermediate position between the closed position and the open position.

FIG. 7 illustrates the cam and the hook while the door is in a subsequent position after the position of FIG. 6 closer to the closed position.

FIG. 8 illustrates the cam and the hook while the door is in a subsequent position after the position of FIG. 7 closer to the closed position.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. The detailed description uses numerical and letter designations to refer to features in the drawings. Like or similar designations in the drawings and description have been used to refer to like or similar parts of the disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. Terms such as “left,” “right,” “front,” “back,” “top,” or “bottom” are used with reference to the perspective of a user accessing the refrigerator appliance. For example, a user stands in front of the refrigerator to open the door(s) and reaches into the food storage chamber(s) to access items therein.

The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

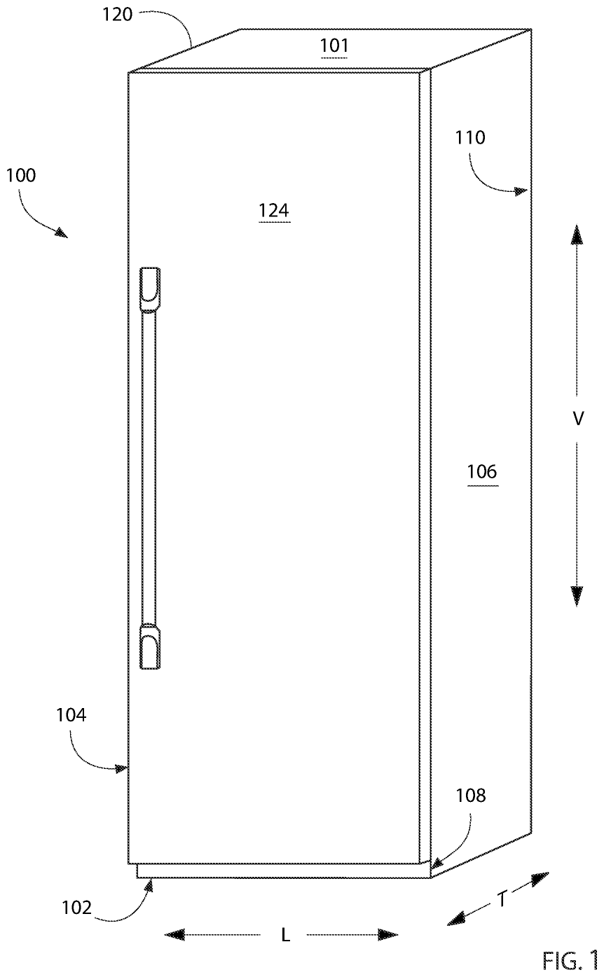

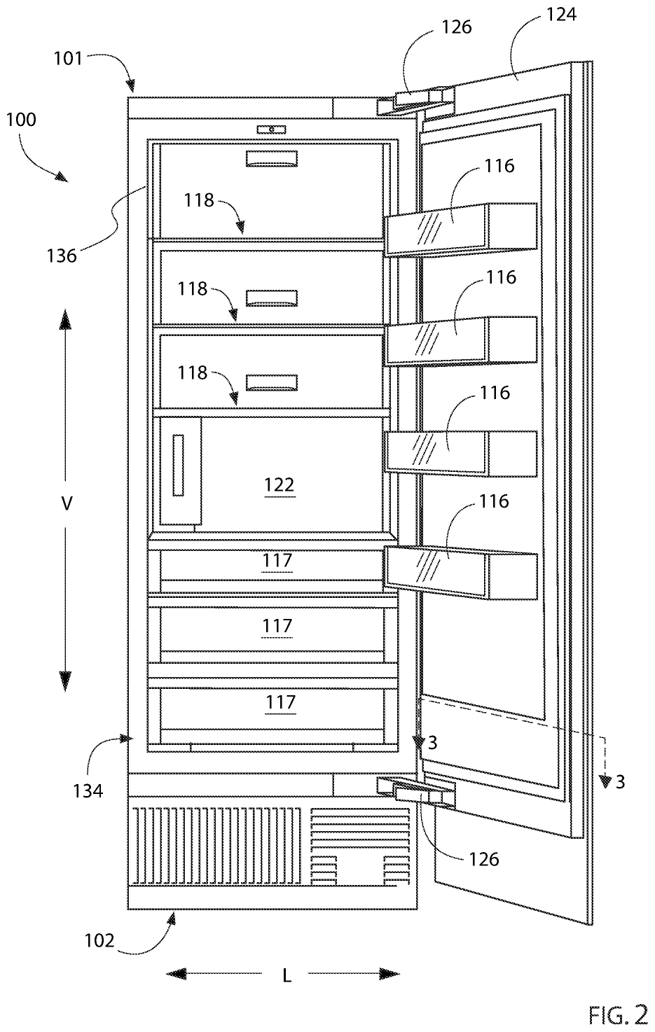

As illustrated in FIGS. 1 and 2, an exemplary refrigerator appliance 100 has an insulated housing or cabinet 120 that defines a food storage chamber 122. A door 124 is provided to selectively sealingly enclose the food storage chamber 122 when in a closed position (FIG. 1) and provide access to the food storage chamber 122 when in an open position (FIG. 2). The door 124 is rotatably mounted to the cabinet 120, such as by one or more hinges 126 (FIG. 2), to rotate between the open position and the closed position.

Refrigerator appliance 100 defines a vertical direction V, a lateral direction L, and a transverse direction T, each mutually perpendicular to one another. As may be seen in FIGS. 1 and 2, the cabinet or housing 120 extends between a top 101 and a bottom 102 along the vertical direction V, between a left side 104 and a right side 106 along the lateral direction L, and between a front 108 and a rear 110 along the transverse direction T. As may be seen in FIG. 2, the food storage chamber 122 includes a front portion 134. The front portion 134 of the food storage chamber 122 defines an opening 136 for receipt of food items. The food storage chamber 122 is a chilled chamber 122 for receipt of food items for storage. As used herein, the chamber may be “chilled” in that the chamber is operable at temperatures below room temperature, e.g., less than about seventy-five degrees Fahrenheit (75° F.). One of ordinary skill in the art will recognize that the food storage chamber 122 may be chilled by a sealed refrigeration system, such that the food storage chamber 122 may be operable at or about the temperatures described herein by providing chilled air from the sealed system. The structure and function of such sealed systems are understood by those of ordinary skill in the art and are not described in further detail herein for the sake of brevity and clarity.

Refrigerator door 124 is rotatably mounted, e.g., hinged, to an edge of cabinet 120 for selectively accessing the fresh food storage chamber 122 within the cabinet 120. Refrigerator door 124 may be mounted to the cabinet 120 at or near the front portion 134 of the food storage chamber 122 such that the door 124 moves, e.g., rotates via hinges 126, between the closed position (FIG. 1) and the open position (FIG. 2). In the closed position of FIG. 1, the door 124 sealingly encloses the food storage chamber 122. Additionally, one or more gaskets and other sealing devices, which are not shown but will be understood by one of ordinary skill in the art, may be provided to promote sealing between the door 124 and the cabinet 120. In the open position of FIG. 2, the door 124 permits access to the fresh food storage chamber 122.

As shown for example in FIG. 2, various storage components may be mounted within the food storage chamber 122 to facilitate storage of food items therein as will be understood by those skilled in the art. In particular, the storage components include bins 116, drawers 117, and shelves 118 that are mounted within fresh food chamber 122. Bins 116, drawers 117, and shelves 118 are configured for receipt of food items (e.g., beverages and/or solid food items) and may assist with organizing such food items.

As depicted, cabinet 120 defines a single chilled chamber 122 for receipt of food items for storage. In the present example, the single chilled chamber 122 is a fresh food chamber 122. In some embodiments, the chilled chamber may be a freezer chamber and/or the refrigerator appliance 100 may include one or more additional chilled chambers for receipt of various food items and storage of such items at various temperatures as desired. For example, the refrigerator appliance 100 may include one or more chilled chambers configured for deep freeze (e.g., at about 0° F. or less) storage, or configured for chilling, e.g., produce or wine, at relatively warmer temperatures such as about 60° F. or more (while still below room temperature, as noted above), as well as any suitable temperatures between the stated examples. In various exemplary embodiments, the chilled chamber 122 may be selectively operable at any number of various temperatures and/or temperature ranges as desired or required per application, and/or the refrigerator appliance 100 may include one or more additional chambers selectively operable at any suitable food storage temperature.

The illustrated exemplary refrigerator appliance 100 is generally referred to as a single-door or single-purpose refrigerator, sometimes also referred to as a column refrigerator. It is recognized, however, that the benefits of the present disclosure apply to other types and styles of refrigerators such as, for example, a bottom mount refrigerator, a top mount refrigerator, a side-by-side style refrigerator, or a freezer appliance. Consequently, the description set forth herein is for illustrative purposes only and is not intended to be limiting in any aspect to a particular refrigerator chamber configuration. Additionally, door hinges as described herein may be useful in other types of appliances such as microwave oven appliances, clothes washer/dryer appliances, etc., and/or other contexts wherever the disclosed features may be desired.

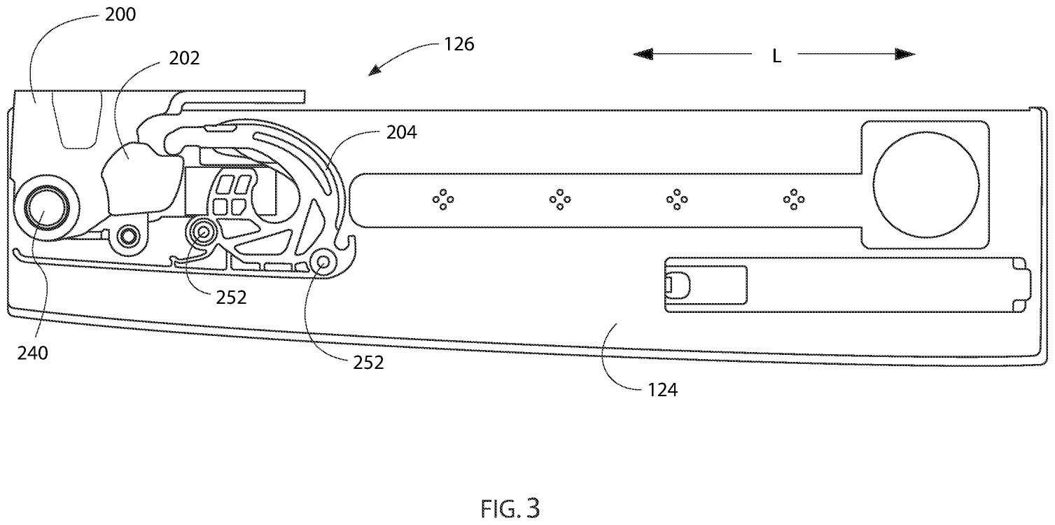

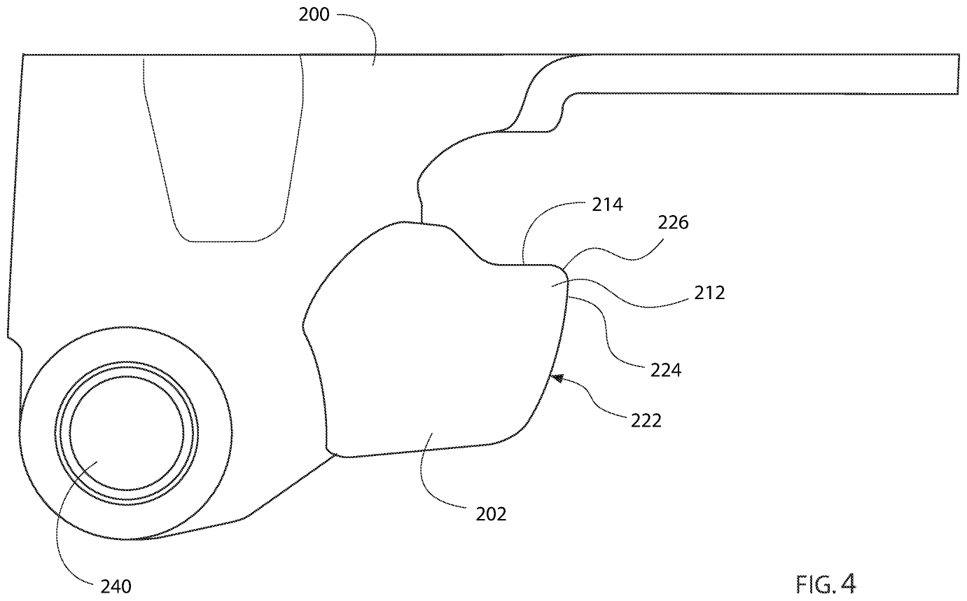

FIG. 3 is a section view taken through the door 124 of the refrigerator appliance 100 (in some embodiments, the door 124 may be one of the doors of the refrigerator appliance, e.g., in embodiments where the refrigerator appliance includes multiple chilled chambers each having at least one door associated therewith and/or where the refrigerator appliance includes a set, e.g., pair, of doors for the fresh food chamber, such as in a French door configuration), looking downwards along the vertical direction V, e.g., as indicated by arrows at line 3-3 in FIG. 2. As such, internal components of the hinge 126 may be seen in FIG. 3, e.g., components of the hinge 126 which are inside of the door 124. It should be noted that FIG. 3 depicts the position and alignment of the hinge 126 when the door 124 is in the closed position. As may be seen in FIG. 3, the hinge 126 includes a hinge bracket 200 and a cam 202 formed on the hinge bracket 200. In some embodiments, the hinge bracket may comprise a metal material and the cam may comprise a plastic material. For example, in such embodiments the plastic material of the cam 202 may be overmolded onto the metal material of the hinge bracket 200. Continuing the example, in some embodiments the metal bracket 200 may include one or more holes 216 (FIG. 4) extending fully through the hinge bracket 200. Such holes 216 may promote bonding of the plastic material of the cam 202 onto the metal material of the hinge bracket 200, such as the plastic material of the cam 202 may flow into and through the hole(s) 216 in the metal bracket 200 during the overmolding process, as is understood by those of ordinary skill in the art, such that the plastic material of the cam 202 extends within the hole 216 (or each hole 216 when multiple holes 216 are provided) as a result of the overmolding. For example, the plastic material of the cam 202 may extend fully through the hole 216 and may completely fill the hole 216.

The hinge 126 may further include a hook 204. The hook 204 may be fixedly mounted to the door 124, e.g., whereby the hook 204 does not move relative to the door 124 during opening and closing of the door 124, such as fixedly mounted by one or more mechanical fasteners 252. The hook 204 may be formed of a plastic material, such as a plastic material which is similar to and/or compatible with the plastic material of the cam 202, e.g., the plastic materials may have approximately the same hardness. Such compatibility of the plastic materials of the cam 202 and the hook 204 may promote extended life of the hinge 126, e.g., by reducing wear on the cam 202 and/or hook 204 which may occur when the cam 202 and hook 204 are comprised of dissimilar or incompatible materials, e.g., when one of the cam 202 and the hook 204 comprises a metal material and the other comprises a plastic material.

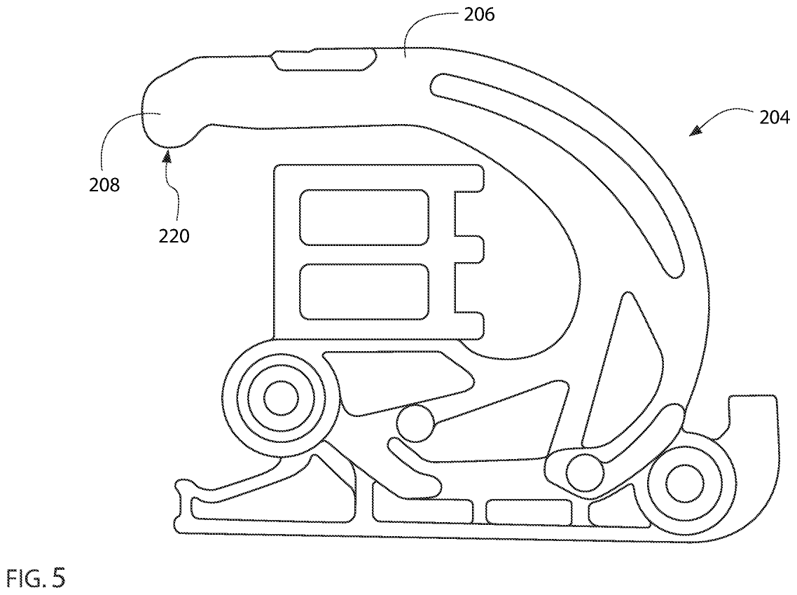

Selected components of the hinge 126 are illustrated in isolation in FIGS. 4 and 5 in order to more clearly depict details of such components. More specifically, the hinge bracket 200 and cam 202 are illustrated in FIG. 4, and the hook 204 is illustrated in FIG. 5. The hook 204 may include a resilient arm 206 and an enlarged head 208 at a distal end or free end 210 of the resilient arm 206. The cam 202 may include a knob 212 and an inner side 214. As may be seen in FIG. 3, the head 208 of the hook 204 may be engaged with the inner side 214 when the door 124 is in the closed position. Such engagement of the hook 204 and the hinge bracket 200 may help ensure that the door 124 is or remains fully closed, e.g., to promote sealing engagement between the door 124 and the cabinet 120.

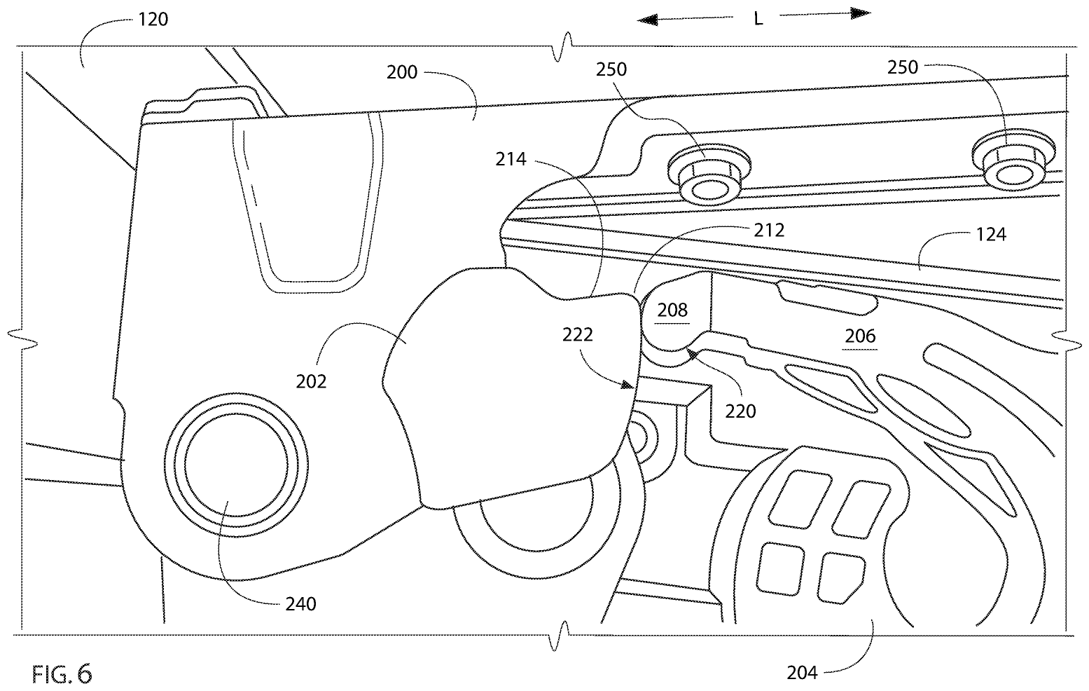

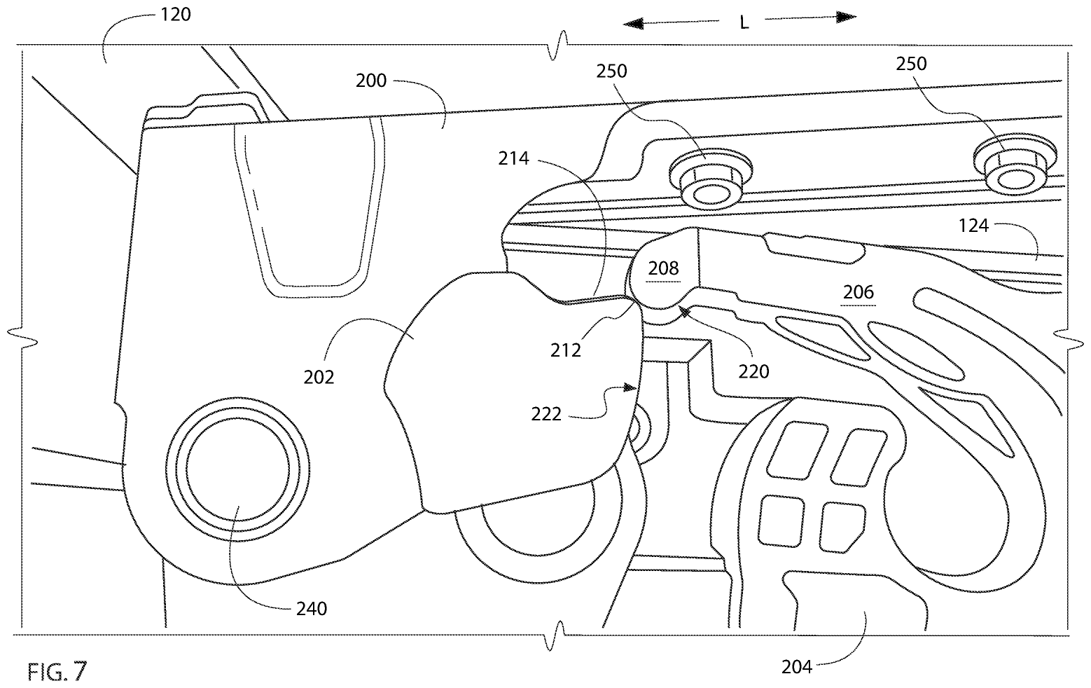

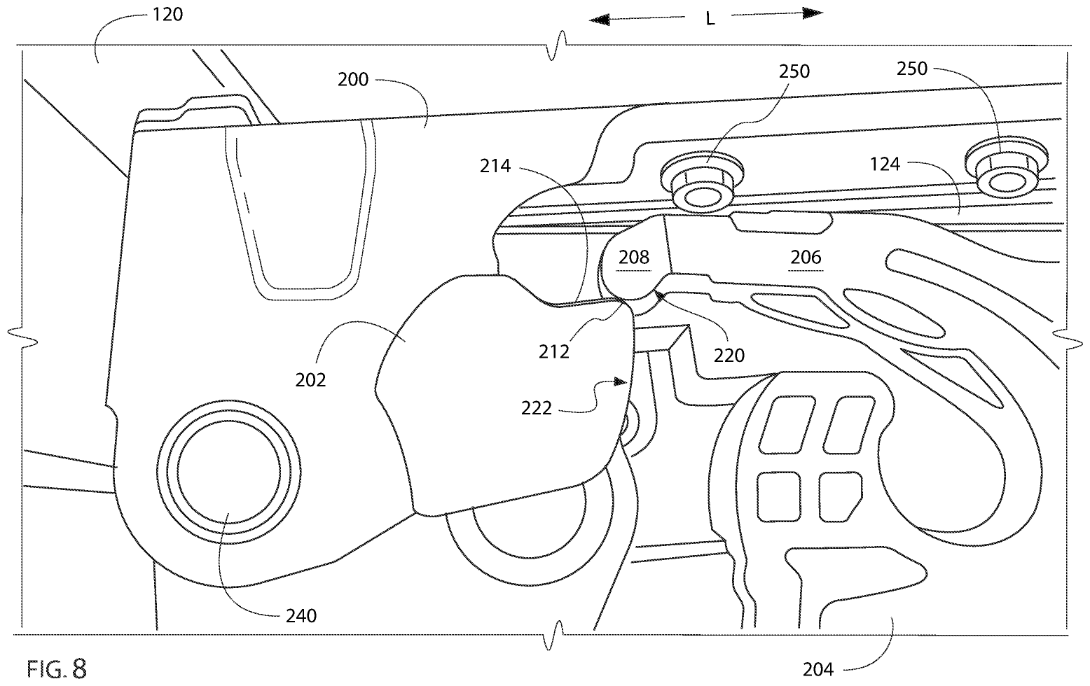

As may be seen in FIGS. 6-8, the hinge bracket 200 may be fixedly mounted to the cabinet 120, e.g., with one or more mechanical fasteners 250. A progression of the door 124 towards the closed position is sequentially illustrated in FIGS. 6-8, e.g., where the door 124 is at least partially open in each of FIGS. 6-8 and is closer to the closed position in FIG. 7 than in FIG. 6, and is closer still to the closed position in FIG. 8 than in FIG. 7, whereas the door 124 is in the closed position in FIG. 3. As may be seen throughout FIGS. 6-8, the hook 204 includes an engagement surface 220, such as a curved surface 220 of the head 208.

As mentioned, the hook 204 may include a resilient arm 206. As may be seen in FIG. 6, the resilient arm 206 may be in a relaxed or neutral position while the door 124 is opened sufficiently that the engagement surface 220 of the hook 204 is in contact with an outer surface 222 of the cam 202. Turning now to FIG. 7, as the door 124 progresses towards the closed position, the engagement surface 220 on the head 208 of the hook 204 passes an end 224 (FIG. 4) of the outer surface 222 and is contact with a convex curved knob 212 of the cam 202, and the shape, e.g., outward curvature, of the knob 212 may be such that the resilient arm 206 is deformed or urged away from the neutral position, e.g., towards the cabinet 120. As may be seen in FIG. 8, when the engagement surface 220 of the hook 204 reaches the apex 226 (FIG. 4) of the knob 212, the hook 204 may be configured to bias the door 124 into the closed position from the position illustrated in FIG. 8. For example, the resiliency of the material of the resilient arm 206 and the shape, e.g., curvature of the head 208 of the hook 204 may serve to bias the door 124 into the closed position from the position illustrated in FIG. 8. For example, the curvature of the head 208 may be configured to guide the head 208 along the knob 212 of the cam 202 and onto the inner side 214 of the cam 202 (e.g., where the head 208 in contact with, e.g., on, the inner side 214 is shown in FIG. 3). For example, the resilient material of the resilient arm 206 may provide a biasing force which urges the resilient arm 206 away from the cabinet 120, e.g., downwards on the page as illustrated in FIG. 8, and towards the neutral position of the resilient arm 206, such that the head 208 of the hook 204 is urged into engagement with the inner side 214 of the cam 202. The hook 204 may thereby urge the door 124 to the closed position, such as to the fully closed position, e.g., wherein the door 124 sealingly engages the cabinet 120 and sealingly encloses the food storage chamber.

As may be seen in FIGS. 6-8, the hook 204 may not interface with the metal material of the hinge bracket 200. For example, the hook 204, and in particular the head 208 and/or engagement surface 220 thereof, may not interface with, such as may not directly contact, the metal material of the hinge bracket 200. Instead, the plastic hook 204 may only interface with, e.g., directly contact, the cam 202, such as the plastic material of the cam 202.

As may be seen in FIGS. 3 and 6-8, the hinge 126 may further include a pivot pin 240 received in the hinge bracket 200. The pivot pin 240 may be oriented generally perpendicular to the hinge bracket 200. For example, the pivot pin 240 may be oriented generally along the vertical direction V, and the hinge bracket 200 may be oriented generally horizontally, e.g., generally perpendicular to the vertical direction V. In such embodiments, the door 124 may be coupled to the pivot pin 240 such that the door 124 is rotatable with respect to the hinge bracket 200. For example, where the hinge bracket 200 is fixedly mounted to the cabinet 120, the door 124 may thusly rotate with respect to the cabinet 120 and the hinge bracket 200 between the open position and the closed position, such as by rotating about the pivot pin 240.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction, a lateral direction, and a transverse direction, the vertical, lateral, and transverse directions being mutually perpendicular, the refrigerator appliance comprising:
a cabinet defining a food storage chamber, the food storage chamber extending between a front portion and a back portion along the transverse direction, the front portion of the food storage chamber defining an opening for receipt of food items; and
a door positioned at the front portion of the food storage chamber, the door coupled to the cabinet by a hinge whereby the door is movable between a closed position and an open position to selectively sealingly enclose the food storage chamber in the closed position and provide access to the food storage chamber in the open position, wherein the hinge comprises:
a hinge bracket fixedly mounted to the cabinet, the hinge bracket comprising a metal material, and
a cam formed on the hinge bracket, the cam comprising a plastic material.

2. The refrigerator appliance of claim 1, further comprising a hook mounted to the door, the hook configured to engage the cam when the door moves from the open position towards the closed position, whereby the hook urges the door to the closed position.

3. The refrigerator appliance of claim 2, wherein the hook comprises a plastic material.

4. The refrigerator appliance of claim 2, wherein the hook does not interface with the metal material of the hinge bracket.

5. The refrigerator appliance of claim 1, wherein the cam is overmolded on the hinge bracket.

6. The refrigerator appliance of claim 1, wherein the hinge bracket comprises a hole extending completely through the metal material.

7. The refrigerator appliance of claim 6, wherein the plastic material of the cam extends within the hole.

8. The refrigerator appliance of claim 1, wherein the hinge further comprises a pivot pin received in the hinge bracket, the pivot pin oriented generally perpendicular to the hinge bracket, the door coupled to the pivot pin such that the door is rotatable with respect to the hinge bracket.

9. The refrigerator appliance of claim 1, wherein the hinge bracket is oriented generally perpendicular to the vertical direction.

10. A hinge for a door of a refrigerator appliance, the door coupled to a cabinet of the refrigerator appliance by the hinge whereby the door is movable between a closed position and an open position, the hinge comprising:
a hinge bracket configured to fixedly mount to a cabinet of the refrigerator appliance, the hinge bracket comprising a metal material; and
a cam formed on the hinge bracket, the cam comprising a plastic material.

11. The hinge of claim 10, further comprising a hook configured to mount to the door, the hook configured to engage the cam when the door moves from the open position towards the closed position, whereby the hook urges the door to the closed position.

12. The hinge of claim 11, wherein the hook comprises a plastic material.

13. The hinge of claim 11, wherein the hook does not interface with the metal material of the hinge bracket.

14. The hinge of claim 10, wherein the cam is overmolded on the hinge bracket.

15. The hinge of claim 10, wherein the hinge bracket comprises a hole extending completely through the metal material.

16. The hinge of claim 15, wherein the plastic material of the cam extends within the hole.

17. The hinge of claim 10, further comprising a pivot pin received in the hinge bracket, the pivot pin oriented generally perpendicular to the hinge bracket, the door coupled to the pivot pin such that the door is rotatable with respect to the hinge bracket.

18. The hinge of claim 10, wherein the hinge bracket is generally horizontal.
